(19) United States
(12) Patent Application Publication
(10) Pub. No.: US 2003/0093254 A1
(43) Pub. Date: May 15, 2003

(54) Distributed simulation system which is agnostic to internal node configuration

(76) Inventors: Carl B. Frankel, San Francisco, CA (US); Carl Cavanagh, Oakland, CA (US); James P. Freyensee, Los Altos, CA (US); Steven A. Sivier, Fremont, CA (US)

Correspondence Address: Lawrence J. Merkel, Conley, Rose, & Tayon, P.C., P.O. Box 398, Austin, TX, 78767, US

(21) Appl. No.: 10/008,255

(22) Filed: Nov. 9, 2001

(51) Int. Cl. G06G 7/62

(52) U.S. Cl. 703/13

(57) ABSTRACT

A distributed simulation system includes at least a first node and a second node. The first node is configured to simulate a first portion of a system under test using a first simulation mechanism. The second node is configured to simulate a second portion of the system under test using a second simulation mechanism different from the first simulation mechanism. The first node and the second node are configured to communicate during a simulation using a predefined grammar. In various embodiments, simulation mechanisms may include one or more of: a simulator and a simulation model of the portion of the system under test; a program coded to simulate the portion; a program designed to provide test stimulus, control, or test monitoring functions for the simulation as a whole; an emulator emulating the portion of the system under test, or a hardware implementation of the portion.

### BACKGROUND OF THE INVENTION

1. Field of the Invention

This invention is related to the field of distributed simulation systems and, more particularly, to communication between nodes in a distributed simulation system.

2. Description of the Related Art

Generally, the development of components for an electronic system such as a computer system includes simulation of models of the components. In the simulation, the specified functions of each component may be tested and, when incorrect operation (a bug) is detected, the model of the component may be changed to generate correct operation. Once simulation testing is complete, the model may be fabricated to produce the corresponding component. Since many of the bugs may have been detected in simulation, the component may be more likely to operate as specified and the number of revisions to hardware may be reduced. The models are frequently described in a hardware description language (HDL) such as Verilog, VHDL, etc. The HDL model may be simulated in a simulator designed for the HDL, and may also be synthesized, in some cases, to produce a netlist and ultimately a mask set for fabricating an integrated circuit.

Originally, simulations of electronic systems were performed on a single computing system. However, as the electronic systems (and the components forming systems) have grown larger and more complex, single-system simulation has become less desirable. The speed of the simulation (in cycles of the electronic system per second) may be reduced due to the larger number of gates in the model which require evaluation. Additionally, the speed may be reduced as the size of the electronic system model and the computer code to perform the simulation may exceed the memory capacity of the single system. In some cases, the simulators may not be capable of simulating the entire model. As the speed of the simulation decreases, simulation throughput is reduced.

To address some of these issues, distributed simulation has become more common. Generally, a distributed simulation system includes two or more computer systems simulating portions of the electronic system in parallel. Each computer system must communicate with other computer systems simulating portions of the electronic system to which the portion being simulated on that computer system communicates, to pass signal values of the signals which communicate between the portions.

### SUMMARY OF THE INVENTION

A distributed simulation system is described which includes at least a first node and a second node. The first node is configured to simulate a first portion of a system under test using a first simulation mechanism. The second node is configured to simulate a second portion of the system under test using a second simulation mechanism different from the first simulation mechanism. The first node and the second node are configured to communicate during a simulation using a predefined grammar.

In various embodiments, simulation mechanisms in the nodes of the distributed simulation system may include one or more of: a simulator and a simulation model of the portion of the system under test; a program coded to simulate the portion; a program designed to provide test stimulus, control, or test monitoring functions for the simulation as a whole; an emulator emulating the portion of the system under test, or a hardware implementation of the portion.

### BRIEF DESCRIPTION OF THE DRAWINGS

The following detailed description makes reference to the accompanying drawings, which are now briefly described.

FIG. 1 is a block diagram of one embodiment of a distributed simulation system.

FIG. 2 is a block diagram illustrating various exemplary node configurations.

FIG. 3 is a flowchart illustrating operation of one embodiment of a parser program which may be part of an API shown in FIG. 2.

FIG. 4 is a flowchart illustrating operation of one embodiment of a formatter program which may be part of an API shown in FIG. 2.

FIG. 5 is a block diagram of one embodiment of a message packet.

FIG. 6 is a table illustrating exemplary commands.

FIG. 7 is a definition, in Backus-Naur Form (BNF), of one embodiment of a POV command.

FIG. 8 is a definition, in BNF, of one embodiment of an SCF command.

FIG. 9 is a definition, in BNF, of one embodiment of a DDF command.

FIG. 10 is an example distributed simulation system.

FIG. 11 is an example POV command for the system shown in FIG. 10.

FIG. 12 is an example SCF command for the system shown in FIG. 10.

FIG. 13 is an example DDF command for the chip1 element shown in FIG. 10.

FIG. 14 is an example DDF command for the chip2 element shown in FIG. 10.

FIG. 15 is an example DDF command for the rst_ctl element shown in FIG. 10.

FIG. 16 is a block diagram of a carrier medium storing the API shown in FIG. 2, including the parser program shown in FIG. 3 and the formatter program shown in FIG. 4.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Distributed Simulation System Overview

In the discussion below, both the computer systems comprising the distributed simulation system (that is, the computer systems on which the simulation is being executed) and the electronic system being simulated are referred to. Generally, the electronic system being simulated will be referred to as the “system under test”.

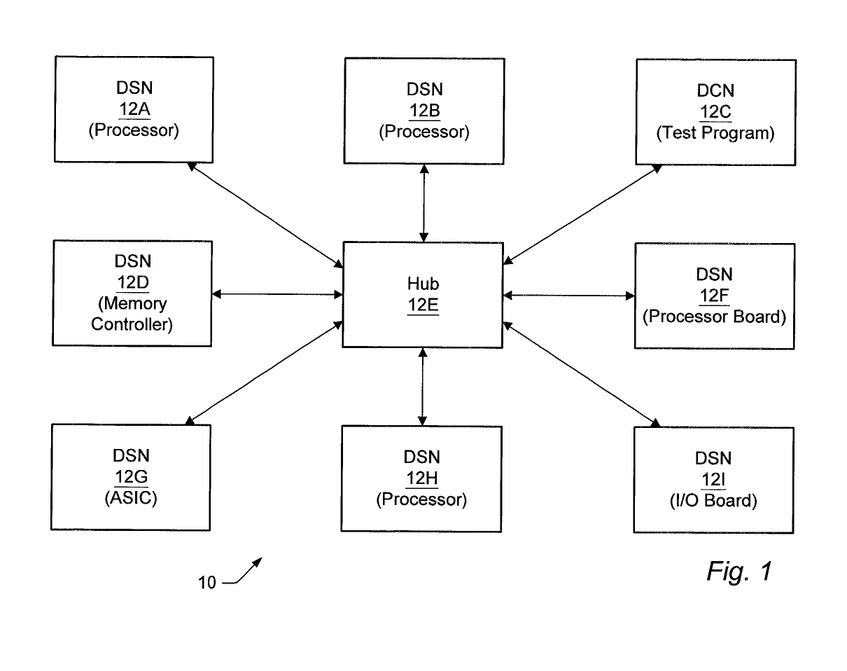

Turning now to FIG. 1, a block diagram of one embodiment of a distributed simulation system 10 is shown. Other embodiments are possible and contemplated. In the embodiment of FIG. 1, the system 10 includes a plurality of nodes 12A-12I. Each node 12A-12D and 12F-12I is coupled to communicate with at least node 12E (which is the hub of the distributed simulation system). Nodes 12A-12B, 12D, and 12F-12I are distributed simulation nodes (DSNs), while node 12C is a distributed control node (DCN).

Generally, a node is the hardware and software resources for: (i) simulating a component of the system under test; or (ii) running a test program or other code (e.g. the hub) for controlling or monitoring the simulation. A node may include one or more of: a computer system (e.g. a server or a desktop computer system), one or more processors within a computer system (and some amount of system memory allocated to the one or more processors) where other processors within the computer system may be used as another node or for some other purpose, etc. The interconnection between the nodes illustrated in FIG. 1 may therefore be a logical interconnection. For example, in one implementation, Unix sockets are created between the nodes for communication. Other embodiments may use other logical interconnection (e.g. remote procedure calls, defined application programming interfaces (APIs), shared memory, pipes, etc.). The physical interconnection between the nodes may vary. For example, the computer systems including the nodes may be networked using any network topology. Nodes operating on the same computer system may physically be interconnected according to the design of that computer system.

A DSN is a node which is simulating a component of the system under test. A component may be any portion of the system under test. For example, the embodiment illustrated in FIG. 1 may be simulating a computer system, and thus the DSNs may be simulating processors (e.g. nodes 12A-12B and 12H), a processor board on which one or more of the processors may physically be mounted in the system under test (e.g. node 12F), an input/output (I/O) board comprising input/output devices (e.g. node 12I), an application specific integrated circuit (ASIC) which may be mounted on a processor board, a main board of the system under test, the I/O board, etc. (e.g. node 12G), a memory controller which may also be mounted on a processor board, a main board of the system under test, the I/O board, etc. (e.g. node 12D).

Depending on the configuration of the system under test, various DSNs may communicate. For example, if the processor being simulated on DSN 12A is mounted on the processor board being simulated on DSN 12F in the system under test, then input/output signals of the processor may be connected to output/input signals of the board. If the processor drives a signal on the board, then a communication between DSN 12A and DSN 12F may be used to provide the signal value being driven (and optionally a strength of the signal, in some embodiments). Additionally, if the processor being simulated on DSN 12A communicates with the memory controller being simulated on DSN 12D, then DSNs 12A and 12D may communicate signal values/strengths.

A DCN is a node which is executing a test program or other code which is not part of the system under test, but instead is used to control the simulation, introduce some test value or values into the system under test (e.g. injecting an error on a signal), monitor the simulation for certain expected results or to log the simulation results, etc.

A DCN may communicate with a DSN to provide a test value, to request a value of a physical signal or other hardware modeled in the component simulated in the DSN, to communicate commands to the simulator in the DSN to control the simulation, etc.

The hub (e.g. node 12E in FIG. 1) is provided for routing communications between the various other nodes in the distributed simulation system. Each DSN or DCN transmits message packets to the hub, which parses the message packets and forwards message packets to the destination node or nodes for the message. Additionally, the hub may be the destination for some message packets (e.g. for synchronizing the simulation across the multiple DSNs and DCNs).

As mentioned above, the communication between the nodes 12A-12I may be in the form of message packets. The format and interpretation of the message packets is specified by a grammar implemented by the nodes 12A-12I. The grammar is a language comprising predefined commands for communicating between nodes, providing for command/control message packets for the simulation as well as message packets transmitting signal values (and optionally signal strength information). Message packets transmitting signal values are referred to as signal transmission message packets, and the command in the message packet is referred to as a transmit command. The grammar may allow for more abstract communication between the nodes, allowing for the communication to be more human-readable than the communication of only physical signals and values of those signals between the nodes. As used herein, a physical signal is a signal defined in the simulation model of a given component of the system under test (e.g. an HDL model or some other type of model used to represent the given component). A logical signal is a signal defined using the grammar. Logical signals are mapped to physical signals using one or more grammar commands.

The grammar may include one or more commands for defining the configuration of the system under test. In one embodiment, these commands include a port of view (POV) command, a device description file (DDF) command, and a system configuration file (SCF) command. These commands may, in one implementation, be stored as files rather than message packets transmitted between nodes in the distributed simulation system. However, these commands are part of the grammar and may be transmitted as message packets if desired.

The POV command defines the logical port types for the system under test. Generally, signal information (which includes at least a signal value, and may optionally include a strength for the signal) is transmitted through a logical port in a message packet. That is, a message packet which is transmitting signal information transmits the signal information for one or more logical ports of a port type defined in the POV command. Accordingly, the POV command specifies the format of the signal transmission message packets. Generally, a logical port is an abstract representation of one or more physical signals. For example, the set of signals which comprises a particular interface (e.g. a predefined bus interface, a test interface, etc.) may be grouped together into a logical port. Transmitting a set of values grouped as a logical port may more easily indicate to a user that a communication is occurring on the particular interface than if the physical signals are transmitted with values.

In one embodiment, the logical ports may be hierarchical in nature. In other words, a given logical port may contain other logical ports. Accordingly, multiple levels of abstraction may be defined, as desired. For example, a bus interface which is pipelined, such that signals are used at different phases in a transaction on the bus interface (e.g. arbitration phase, address phase, response phase, etc.) may be grouped into logical ports for each phase, and the logical ports for the phases may be grouped into a higher level logical port for the bus as a whole. Specifically, in one embodiment, a logical port comprises at least one logical port or logical signal, and may comprise zero or more logical ports and zero or more logical signals in general. Both the logical ports and the logical signals are defined in the POV command. It is noted that the term “port” may be used below instead of “logical port”. The term “port” is intended to mean logical port in such contexts.

The DDF command is used to map logical signals (defined in the POV command) to the physical signals which appear in the models of the components of the system under test. In one embodiment, there may be at least one DDF command for each component in the system under test.

The SCF command is used to instantiate the components of the system under test and to connect logical ports of the components of the system under test. The SCF command may be used by the hub for routing signal transmission message packets from one node to another.

In addition to the above mentioned commands, the grammar may include a variety of other commands. For example, commands to control the start, stop, and progress of the simulation may be included in the grammar. An exemplary command set is shown in more detail below.

While the embodiment shown in FIG. 1 includes a node operating as a hub (node 12E), other embodiments may not employ a hub. For example, DSNs and DCNs may each be coupled to the others to directly send commands to each other. Alternatively, a daisy chain or ring connection between nodes may be used (where a command from one node to another may pass through the nodes coupled therebetween). In some embodiments including a hub, the hub may comprise multiple nodes. Each hub node may be coupled to one or more DSN/DCNs and one or more other hub nodes (e.g. in a star configuration among the hub nodes). In some embodiments, a DCN or DSN may comprise multiple nodes.

Node Agnosticity

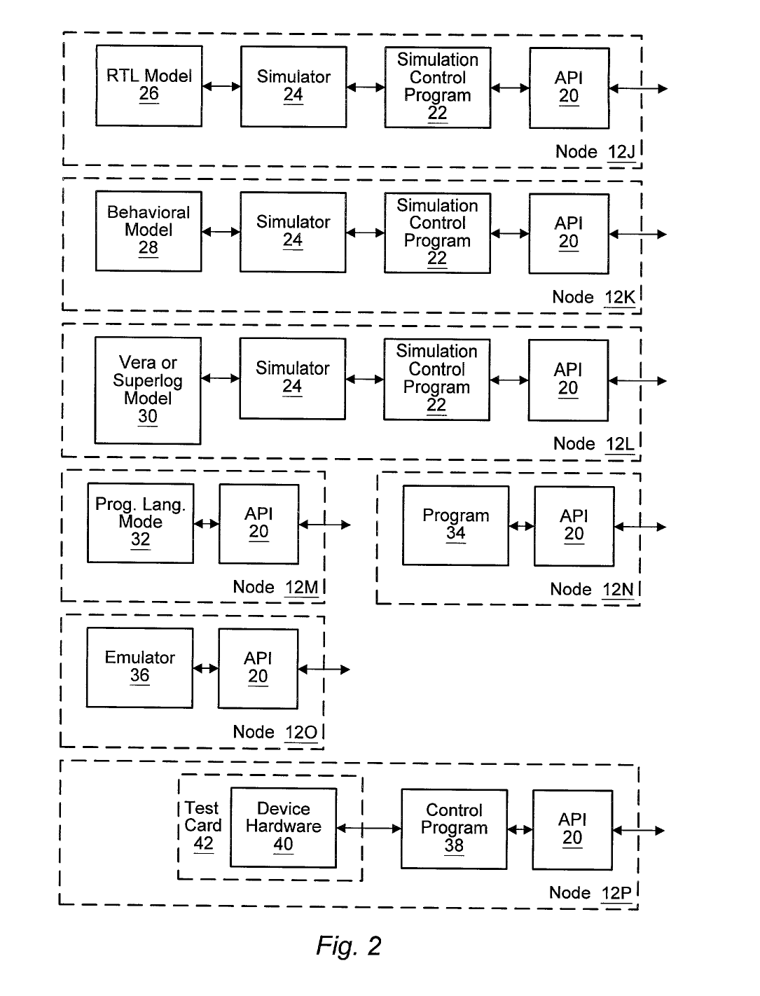

The grammar provides a predefined communication mechanism for communicating between the nodes in a distributed simulation. Accordingly, each node may use different simulation mechanisms as long as the node communicates with other nodes using the grammar. Generally, a simulation mechanism may include software and/or hardware components for performing a simulation of the portion of the system under test being simulated in the node. Various examples of simulation mechanisms are shown in FIG. 2.

Turning now to FIG. 2, a block diagram of several exemplary nodes 12J-12P are shown. Other embodiments are possible and contemplated. Any of the nodes 12J-12P may be used as any of nodes 12A-12D or 12F-12I shown in FIG. 1 to form a distributed simulation system. Moreover, any combination of two or more of the nodes 12J-12P may be included to form a distributed simulation system. Each node 12J-12P as illustrated in FIG. 2 may include software components and/or hardware components forming the simulation mechanism within that node. For software components, the illustration may be logical in nature. Various components may actually be implemented as separate programs, combined into a program, etc. Generally, a program is a sequence of instructions which, when executed, provides predefined functionality. The term “code” as used herein may be synonymous with program.

Each of the nodes 12J-12P as illustrated in FIG. 2 includes an application programming interface (API) 20 which is configured to interface to other components within the node and is configured to transmit communications from the other components and receive communications for the other components according to the grammar used in the distributed simulation system. The API 20 may have a standard interface to other components used in each of the exemplary nodes 12J-12P, or may have a custom interface for a given node. Furthermore, the API 20 may physically be integrated into the other software components within the node.

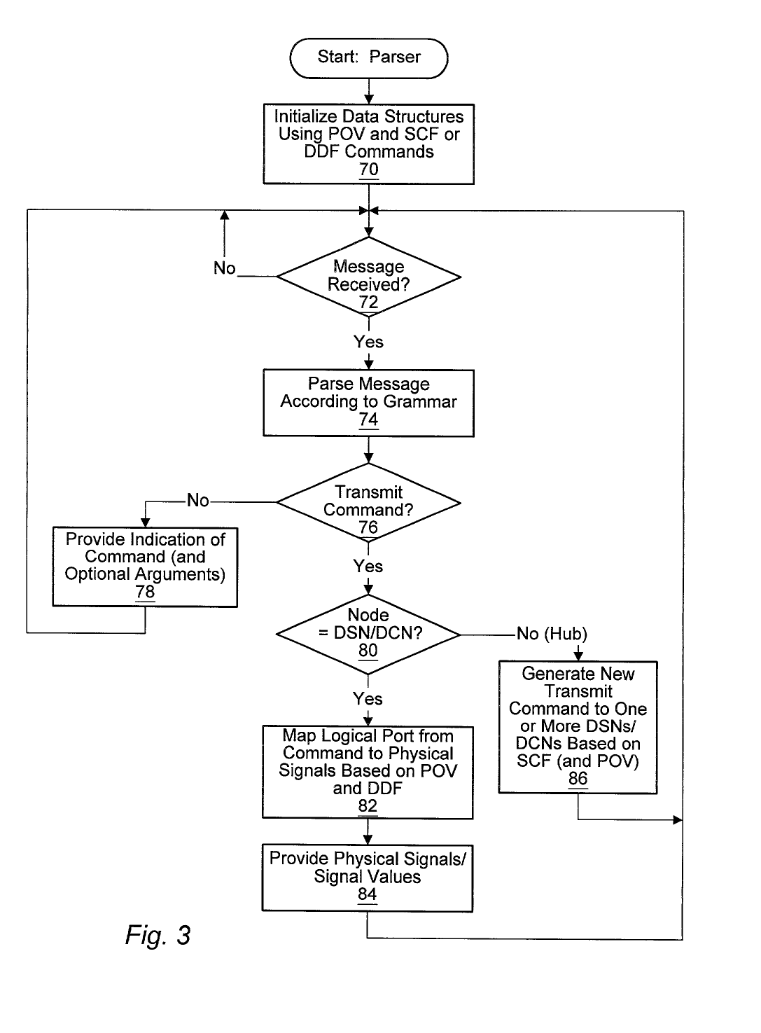

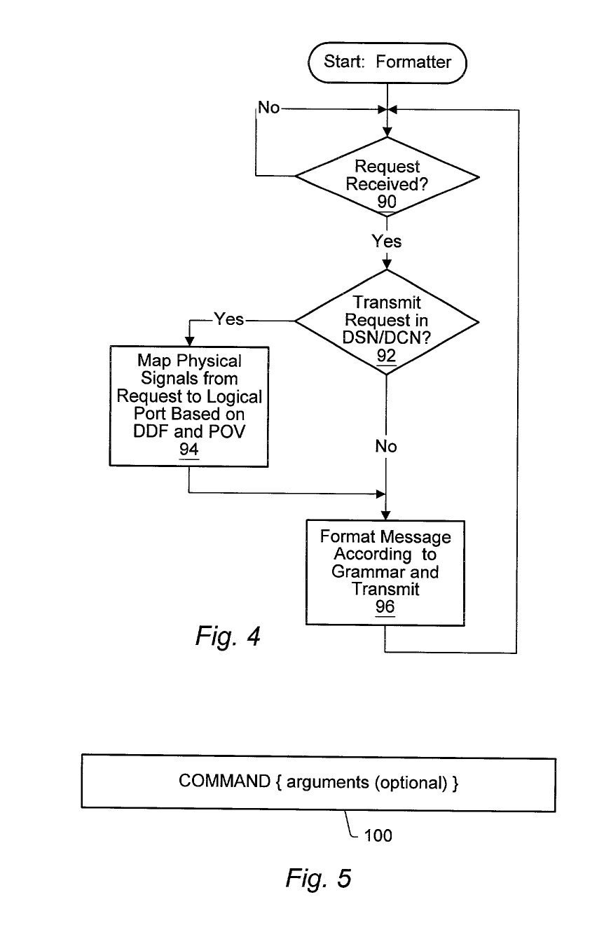

Generally, the API 20 may include one or more programs for communicating with the other components within the node and for generating and receiving communications according to the grammar. In one embodiment, the API 20 may include a parser for parsing message packets received from other nodes and a formatter for formatting message packets for transmission in response to requests from other components within the node. Flowcharts illustrating one embodiment of a parser and a formatter are shown in FIGS. 3 and 4.

The node 12J includes the API 20, a simulation control program 22, a simulator 24, and a register transfer level (RTL) model 26. Generally, the simulation control program 22 may be configured to interface with the simulator 24 to provide simulation control, test stimulus, etc. The simulation control program 22 may include custom simulation code written to interface to the simulator 24, such as Vera® code which may be called at designated times during a simulation timestep by the simulator 24. Vera® may be a hardware verification language. A hardware verification language may provide a higher level of abstraction than an HDL. The custom simulation code may include code to react to various grammar commands which may be transmitted to the node (e.g. if the command includes signal values, the simulation control program 22 may provide the signal values to the simulator 24 for driving on the model 26).

The simulator 24 may generally be any commercially available simulator program for the model 26. For example, Verilog embodiments may employ the VCS simulator from Synopsys, Inc. (Mountain View, Calif.); the NCVerilog simulator from Cadence Design Systems, Inc. (San Jose, Calif.); the VerilogXL simulator from Cadence; or the SystemSim program from Co-Design Automation, Inc. of Los Altos, Calif., or any other similar Verilog simulator. In one embodiment, the simulator 26 is an event driven simulator, although other embodiments may employ any type of simulator including cycle based simulators. The SystemSim simulator may support Superlog, which may be a superset of Verilog which supports constructs for verification and an interface to C, C++, etc.

Generally, the RTL model 26 may be a simulatable model of a portion of the system under test. The model may be derived from an HDL representation of the portion. Exemplary HDLs may include Verilog, VHDL, etc. The representation may be coded at the RTL level, and them may be compiled into a form which is simulatable by the simulator 24. Alternatively, the simulator 24 may be configured to simulate the HDL description directly.

A register-transfer level description describes the corresponding portion of the system under test in terms of state (e.g. stored in clocked storage elements such as registers, flip-flops, latches, etc.) and logical equations on that state and other signals (e.g. input signals to the component) to produce the behavior of the portion on a clock cycle by clock cycle basis.

The node 12K includes the API 20, the simulation control code 22, the simulator 24, and a behavioral model 28. The behavioral model 28 may be similar to the RTL model 26, except that the HDL description may be written at the behavioral level. Behavioral level descriptions describe functionality algorithmically, without necessarily specifying any state stored by the corresponding circuitry or the logical equations on that state used to produce the functionality. Accordingly, behavioral level descriptions may be more abstract that RTL descriptions.

The node 12L includes the API 20, the simulation control code 22, the simulator 24, and a Vera® model 30. The Vera® model 30 may be coded in the Vera® language, and may be executed by the simulator 24. Alternatively, a Superlog model may be used.

For each of the nodes 12J, 12K, and 12L, the simulation mechanism may thus include the simulation control program 22, the simulator 24, and the model 26, 28, or 30. In some embodiments, the simulation control program 22 may not be used and thus the simulation mechanism may include the simulator 24 and the model 26, 28, or 30.

The node 12M includes the API 20 and a program which models the portion of the system under test (a programming language model 32). In this case, the functionality of the portion being simulated is coded as a standalone program, rather than a model to be simulated by a simulator program. The programming language model 32 may be coded in any desired programming language (e.g. C, C++, Java, etc.) and may be compiled using any commercially available compiler to produce the programming language model 32. Thus, in the case of the node 12M, the simulation mechanism may comprise the programming language model 32. While the programming language model 32 is described as a program, other embodiments may employ one or more programs to implement the programming language model 32.

The node 12N includes the API 20 and a program 34. The program 34 may not necessarily model any particular portion of the system under test, but may provide control functions for the distributed simulation as a whole, test stimulus, etc. The node 12N may be used in a DCN such as node 12C, for example. Thus, in the case of the node 12N, the simulation mechanism may comprise the program 34. Other embodiments may employ one or more programs 34, as desired.

The node 12O includes the API 20 and an emulator 36. Generally, the emulator 36 may use hardware assistance to accelerate simulation. For example, an emulator 36 may include a plurality of programmable logic devices (PLDs) such as field programmable gate arrays (FPGAs) which may be programmed to perform the functionality corresponding to the portion of the system under test. The emulator 36 may further include software for receiving a description of the portion (e.g. an HDL description at the behavioral or RT level) and for mapping the description into the PLDs. The software may also be configured to manage the simulation. The software may sample signals from the emulator hardware for transmission to other nodes and may drive signals to the emulator hardware in response to signal values received from other nodes. Exemplary emulators may include the emulation products of Quickturn Design Systems (a Cadence company), In this case, the simulation mechanism may include the emulator 36.

The node 12P includes the API 20, a control program 38, and device hardware 40 (e.g. on a test card 42). The device hardware 40 may be the hardware implementing the portion of the system under test being simulated in the node 12P. The device hardware may be included on the test card 42, which may include circuitry for interfacing to the device hardware 40 and for interfacing to the computer system on which the simulation is being run (e.g. via a standard bus such as the PCI bus, IEEE 1394 interconnect, Universal Serial Bus, a serial or parallel link, etc.).

The control program 38 may be configured to interface to the device hardware 40 through the test card 42, to sample signals from the device hardware 40 (for transmission to other nodes) and to drive signals to the device hardware 40 (received from other nodes). The control program 38 may further be configured to control the clocking of the device hardware 40 (through the test card 42), so that the operation of the device hardware 40 may be synchronized to the other portions of the system under test. In this case, the simulation mechanism may include the device hardware and the control program 38. The simulation mechanism may further include the test card 42 (or similar circuitry implemented in another fashion than a test card).

In one embodiment, the distributed simulation system may synchronize the simulations in the nodes such that the nodes transition between timesteps of an event based simulation is synchronized. The grammar may include commands for maintaining the synchronization, and each node may implement the synchronization in its simulation mechanism (or the API 20).

Exemplary Grammar

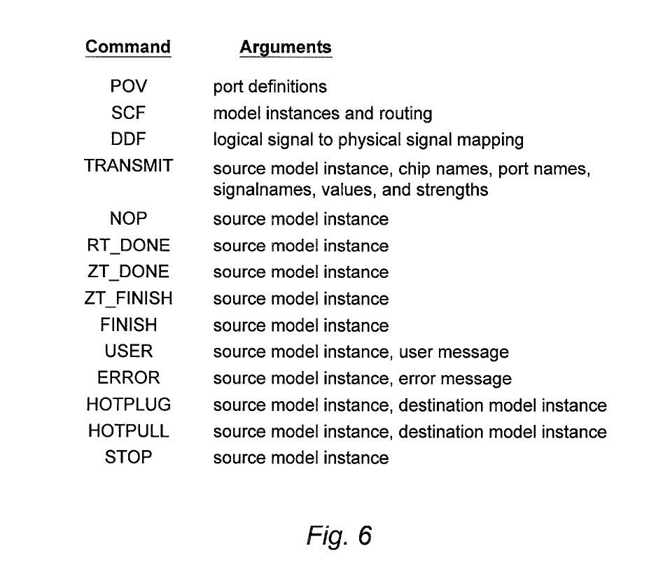

An example grammar is next described. Other embodiments are possible and contemplated. The grammar may define a more human readable message packet format, which may allow the user to more readily learn to use the distributed simulation system, to interpret the sequence of events within the system, and to control the simulation in a desired fashion. For example, abstract simulation commands may be defined, which the user may employ to implement a desired test. An exemplary set of commands is shown in FIG. 6.

The description below may in some cases refer to DSNs having models executed by simulators (e.g. models similar to models 26, 28, and 30). Similar operation may be provided by the programming language model 32. In one embodiment, the programming language model 32 may operate in a similar fashion as the combination of the simulator and the model. In some embodiments, the programming language model 32 may be programmed to operate on the logical signals and ports defined in the POV command (and thus mapping to physical signals may be avoided). Such embodiments may omit a DDF command for the nodes having the programming language model 32. Other embodiments may use the physical signals in the programming language model 32, and the DDF command may be used. The program 34 may use the POV command for formulating packets, but again may not have a DDF command if desired. Nodes having the emulator 36 may use DDF commands with the physical signal names, since the emulator may be accelerating an HDL description of the portion of the system under test. The emulator 36 may include an additional mapping from physical signals to signals on the PLDs in the emulator hardware. Nodes having the device hardware 40 may again use physical signals (and the DDF command) and the control program 38 may map physical signal names to pins on the device hardware 40. Alternatively, the control program 38 may map logical signals to pins and the DDF command may be omitted.

Turning now to FIG. 3, a flowchart is shown illustrating operation of one embodiment of a parser which may be included in one embodiment of the API 20. Other embodiments are possible and contemplated. Blocks are illustrated in a particular order for ease of understanding, but any order may be used. Blocks may be performed in parallel, if desired. Generally, the flowchart of FIG. 3 may represent a sequence of instructions comprising the parser which, when executed, perform the operation shown in FIG. 3.

The parser initializes data structures used by the parser (and the formatter illustrated in FIG. 4) using the POV command and the SCF or DDF commands, if applicable (block 70). Alternatively, block 70 may be performed by an initialization routine or initialization script separate from the parser. The data structures formed from the POV command and the SCF or DDF commands may be any type of data structure which may be used to store the information conveyed by the commands. For example, hash tables may be used.

The parser waits for a message packet to be received (decision block 72). The decision block 72 may represent polling for a message packet, or may represent the parser being inactive (“asleep”) until a call to the parser is made with the message packet as an operand.

In response to a message packet, the parser parses the message packet according to the grammar (block 74). The grammar specifies the format and content of the message packet at a high level, and additional specification for signal transmission message packets is provided by the POV command defined in the grammar. The grammar may be defined in the Backus-Naur Form (BNF), allowing a software tool such as the Unix tools lex/flex and yacc/bison to be used to automatically generate the parser.

In the present embodiment, the same parser may be used in the hub and the DCNs/DSNs. However, in other embodiments, separate parsers may be created for the hub and for the DCNs/DSNs. In such embodiments, the parser for the hub may implement the hub portion of the flowchart in FIG. 3 and the parser for the DCNs/DSNs may implement the DCN/DSN portion of the flowchart in FIG. 3.

If the message packet is not a transmit command (a signal transmission message packet) (block 76), then the message packet is a command for the receiving program to process (e.g. the simulation control program 22, the programming language model 32, the program 34, the emulator 36 software, or the control program 38 in FIG. 2). The parser may provide an indication of the received command, as well as an indication of arguments if arguments are included, to the receiving program (block 78). The receiving program may respond to the message as appropriate. The parser waits for the next message to be received.

If the message packet is a transmit command, the operation depends on whether the node is a DSN/DCN or a hub (decision block 80). If the node is a DSN/DCN, the parser maps the logical port in the transmit command to physical signals, using the information provided in the POV and DDF commands (block 82). The parser may then provide the physical signal names and corresponding values to the receiving code (block 84). The parser waits for the next message to be received.

If the node is a hub, the parser may generate new transmit commands to one or more other DSNs/DCNs according to the port connections specified in the SCF command (and POV commands) (block 86). Specifically, the SCF may specify routings from a port on which a transmit command is received to one or more other ports in other nodes. Each routing expression may be viewed as a connection between the port on which the transmit command is received and the other port in the routing expression. Each routing results in a new transmit command, provided to the thread/socket which communicates with the destination node of that routing. The SCF command may specify the information used to generate the new transmit command in the routing expression. Specifically, as shown in more detail below, the routing expression includes a model instance name and one or more port names (where, if more than one port name is included, the ports are hierarchically related). Accordingly, the model instance name and the port names of the destination portion of the expression may be used to replace the model instance name and port names in the received transmit command to generate the new transmit command. The parser waits for the next message to be received.

It is noted that the parser may also be configured to detect a message packet which is in error (that is, a message packet which is unparseable according to the grammar). Error handling may be performed in a variety of fashions. For example, the erroneous message packet may be ignored. Alternatively, the parser may pass an indication of an error to the receiving program, similar to block 78. In yet another alternative, the parser may return an error message to the hub (or provide an error indication to the formatter 34, which may return an error message packet).

Turning now to FIG. 4, a flowchart is shown illustrating operation of one embodiment of the formatter that may be included in one embodiment of the API 20. Other embodiments are possible and contemplated. Blocks are illustrated in a particular order for ease of understanding, but any order may be used. Blocks may be performed in parallel, if desired. Generally, the flowchart of FIG. 4 may represent a sequence of instructions comprising the formatter which, when executed, perform the operation shown in FIG. 4.

The formatter waits for a request to send a message packet (decision block 90). The decision block 90 may represent polling for a request, or may represent the formatter being inactive until a call to the formatter is made with the request information as an operand.

If the request is a transmit request in a DSN/DCN (decision block 92), the formatter maps the physical signals provided in the request to a logical port based on the DDF and POV commands (block 94). The formatter may use the same data structures used by the parser (created from the DDF and POV commands), or separate data structures created for the formatter from the DDF and POV commands. Generally, a request to transmit signals may include signals that belong to different logical ports. The formatter may generate one message packet per logical port, or the transmit command may handle multiple ports in one message packet. Alternatively, the request may include the logical signals and the formatter may not perform the mapping from physical signals to logical signals.

The formatter formats a message packet according to the grammar definition and transmits the message packet to the socket (block 96). An example message packet is shown in FIG. 5.

Turning next to FIG. 5, a block diagram of a message packet 100 is shown. Other embodiments are possible and contemplated. Generally, a message packet is a packet including one or more commands and any arguments of each command. The message packet may be encoded in any fashion (e.g. binary, text, etc.). In one embodiment, a message packet is a string of characters formatted according to the grammar. The message packet may comprise one or more characters defined to be a command (“COMMAND” in FIG. 5), followed by an opening separator character (defined to be an open brace in this embodiment, but any character may be used), followed by optional arguments, followed by a closing separator character (defined to be a close brace in this embodiment, but any character may be used). In BNF, the packet may be described as: COMMAND “{“arguments”}”. COMMAND is a token comprising any string of characters which is defined to be a command. A list of commands are illustrated in FIG. 6 for an exemplary embodiment. Arguments are defined as: | arguments one_argument. One_argument has a definition which depends on the command type.

It is noted that, when BNF definitions are used herein, words shown in upper case are tokens for the lexer used in the generation of the parser while words shown in lower case are terms defined in other BNF expressions.

FIG. 6 is a table illustrating an exemplary set of commands and the arguments allowed for each command. Other embodiments may include other command sets, including subsets and supersets of the list in FIG. 6. Under the Command column is the string of characters used in the message packet to identify the command. Under the Arguments column is the list of arguments which may be included in the command.

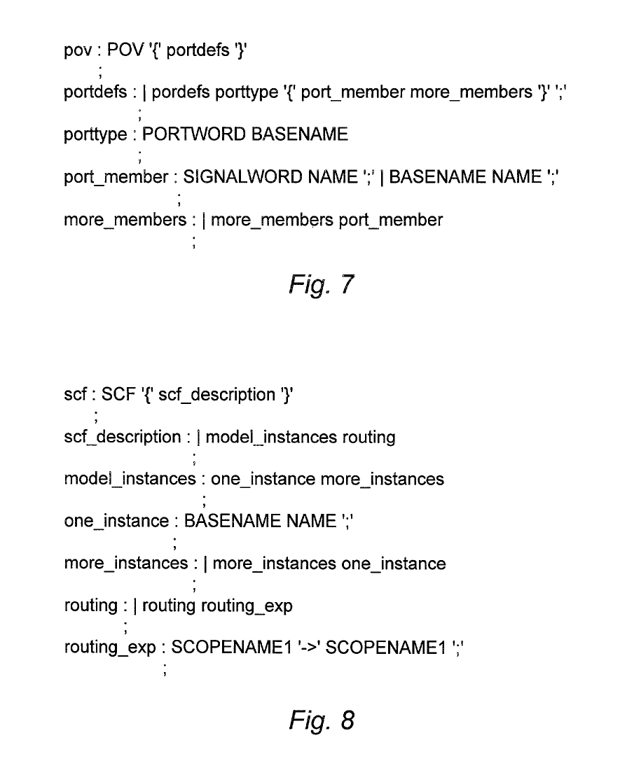

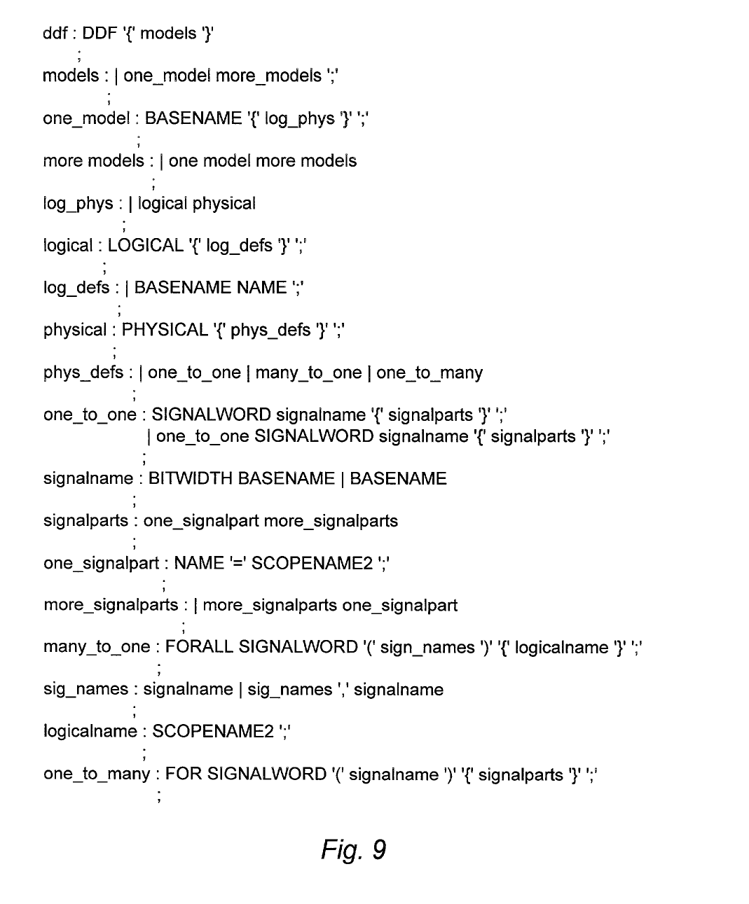

The POV, SCF, and DDF commands have been introduced in the above description. Additionally, FIGS. 7-9 provide descriptions of these commands in BNF. Generally, the POV command has the port type definitions as its arguments; the SCF command has model instances (i.e. the names of the models in each of the DSNs) and routing expressions as its arguments; and the DDF command has logical signal to physical signal mappings as its arguments. These commands will be described in more detail below with regard to FIGS. 7-9.

The TRANSMIT command is used to transmit signal values from one port to another. That is, the TRANSMIT command is the signal transmission message packet in the distributed simulation system. Generally, the transmit command includes the name of the model for which the signals are being transmitted (which is the model name of the source of the signals, for a packet transmitted from a DSN/DCN to the hub, or the model name of the receiver of the signals, for a packet transmitted by the hub to a DSN/DCN), one or more ports in the port hierarchy, logical signal names, and assignments of values to those signal names. For example, the TRANSMIT command may be formed as follows:

TRANSMIT{model{port{signalname={value=INT;strength=POTENCY;}; }}}

Where the port may include one or more subports (e.g. port may be port{subport, repeating subport as many times as needed to represent the hierarchy of ports until the logical signal names are encountered). Additional closing braces would be added at the end to match the subport open braces. The TRANSMIT command may be represented in BNF as follows:

```
transmit : TRANSMIT ′{′ chip ′{′ ports ′}′′}′
      ;
chip : chipportname
    ;
ports : | ports chipportname ′{′ ports data ′}′
    ;
chipportname : PORT
          ;
data : | data dataline ports
    ;
dataline : NAME ′=′ ′{′ signalparts ′}′
      ;
signalparts : VALUE ′=′ INT ′;′
| VALUE ′=′ INT ′;′ STRENGTH ′=′ POTENCY ′;′
| VALUE ′=′ BIN ′;′
| VALUE ′=′ BIN ′;′ STRENGTH ′=′ POTENCY ′;′
| VALUE ′=′ HEX ′;′
| VALUE ′=′ HEX ′;′ STRENGTH ′=′ POTENCY ′;′
;
```

where the following are the token definitions: TRANSMIT is the “TRANSMIT” keyword, PORT is a port type defined in the POV command (preceded by a period, in one embodiment), NAME is a logical signal name, VALUE is the “value” keyword, INT is an integer number, BIN is a binary number, and HEX is a hexadecimal number, STRENGTH is the “strength” keyword, and POTENCY is any valid signal strength as defined in the HDL being used (although the actual representation of the strength may vary).

The signal strength may be used to simulate conditions in which more than one source may be driving a signal at the same time. For example, boards frequently include pull up or pull down resistors to provide values on signals that may not be actively driven (e.g. high impedance) all the time. An active drive on the signal may overcome the pull up or pull down. To simulate such situations, signal strengths may be used. The pull up may be given a weak strength, such that an active drive (given a strong strength) may produce a desired value even though the weak pull up or pull down is also driving the same signal. Thus signal strength is a relative indication of the ability to drive a signal to a desired value. In one embodiment, the signal strengths may include the strengths specified by the IEEE 1364-1995 standard. For example, the strengths may include (in order of strength from strongest to weakest): supply drive, strong drive, pull drive, large capacitor, weak drive, medium capacitor, small capacitor and high impedance. The strengths may also include the 65× strength (an unknown value with a strong driving 0 component and a pull driving 1 component) and a 520 strength (a 0 value with a range of possible strengths from pull driving to medium capacitor).

The NOP command is defined to do nothing. The NOP command may be used as an acknowledgment of other commands, to indicate completion of such commands, for synchronization purposes, etc. The NOP command may have a source model instance argument in the present embodiment, although other embodiments may include a NOP command that has no arguments or other arguments The NOP command may also allow for reduced message traffic in the system, since a node may send a NOP command instead of a transmit command when there is no change in the output signal values within the node, for example.

The RT_DONE, ZT_DONE, ZT_FINISH, and FINISH commands may be used to transition DSNs between two phases of operation in the distributed simulation system, for one embodiment. In this embodiment, each simulator timestep includes a real time phase and a zero time phase. In the real time phase, simulator time advances within the timestep. In the zero time phase, simulator time is frozen. Messages, including TRANSMIT commands, may be performed in either phase. The RT_DONE command is used by the hub to signal the end of a real time phase, and the ZT_DONE command is used by the hub to indicate that a zero time phase is done. The ZT_FINISH command is used by the DSN/DCN nodes to signal the end of a zero time phase in asynchronous embodiments of zero time. The FINISH command is used to indicate that the simulation is complete. Each of the RT_DONE, ZT_DONE, ZT_FINISH, and FINISH commands may include a source model instance argument.

The USER command may be used to pass user-defined messages between nodes. The USER command may provide flexibility to allow the user to accomplish simulation goals even if the communication used to meet the goals is not directly provided by commands defined in the grammar. The arguments of the USER command may include a source model instance and a string of characters comprising the user message. The user message may be code to be executed by the receiving node (e.g. C, Vera®, Verilog, etc.), or may be a text message to be interpreted by program code executing at the receiving node, as desired. In one embodiment, the routing for the USER command is part of the user message.

The ERROR command may be used to provide an error message, with the text of the error message and a source model instance being arguments of the command.

The HOTPLUG and HOTPULL commands may be used to simulate the hot plugging or hot pulling of a component. A component is “hot plugged” if it is inserted into the system under test while the system under test is powered up (i.e. the system under test, when built as a hardware system, is not turned off prior to inserting the component). A component is “hot pulled” if it is removed from the system under test while the system is powered up. A node receiving the HOTPLUG command may begin transmitting and receiving message packets within the distributed simulation system. A node receiving the HOTPULL command may cease transmitting message packets or responding to any message packets that may be sent to the node by other nodes. The HOTPLUG and HOTPULL commands may include a source model instance argument and a destination model instance argument (where the destination model instance corresponds to the component being hot plugged or hot pulled).

The STOP command may be used to pause the simulation (that is, to freeze the simulation state but not to end the simulation). The STOP command may include a source model instance argument.

FIGS. 7-9 are BNF descriptions of the POV, SCF, and DDF commands, respectively, for one embodiment of the grammar. Other embodiments are possible and contemplated. As mentioned above, the words shown in upper case are tokens for the lexer used in the generation of the parser while words shown in lower case are terms defined in other BNF expressions.

Generally, the POV command includes one or more port type definitions. In the present embodiment, the POV command includes two data types: ports and signals. Signals are defined within ports, and ports may be members of other ports. The signal is a user defined logical signal, and the port is a grouping of other ports and/or signals. Each port type definition begins with the “port” keyword, followed by the name of the port, followed by a brace-enclosed list of port members (which may be other ports or signals). Signals are denoted in a port definition by the keyword “signal”. Ports are denoted in a port definition by using the port name, followed by another name used to reference that port within the higher level port.

The SCF command includes an enumeration of the model instances within the system under test (each of which becomes a DSN or DCN in the distributed simulation system) and a set of routing expressions which define the connections between the logical ports of the model instances. The model instances are declared using a model type followed by a name for the model instance. A DDF command is provided for the model type to define its physical signal to logical signal mapping. The model name is used in the TRANSMIT commands, as well as in the routing expressions within the SCF command. Each routing expression names a source port and a destination port. TRANSMIT commands are routed from the source port to the destination port. The port name in these expressions is hierarchical, beginning with the model instance name and using a “.” as the access operator for accessing the next level in the hierarchy. Thus, a minimum port specification in a routing expression is of the form model_name.port_name1. A routing expression for routing the port_name2 subport of port_name1 uses model_name.port_name1.port_name2. In this example, a routing expression of the form model_name.port_name1 may route any signals encompassed by port_name1 (including those within port_name2). On the other hand, a routing expression of the form model_name.port_name1.port_name2 routes only the signals encompassed by port_name2 (and not other signals encompassed by port_name1 but not port_name2). The routing operator is defined, in this embodiment, to be “−>” where the source port is on the left side of the routing operator and the destination port is on the right side of the routing operator.

In the SCF command, bi-directional ports may be created using two routing expressions. In another embodiment, one routing expression may be used to specify bi-directional ports. The first routing expression routes the first port (as a source port) to the second port (as a destination port) and the second routing expression routes the second port (as a source port) to the first port (as a destination port). Additionally, a single port may be routed to two or more destination ports using multiple routine expressions with the single port as the source port and one of the desired destination ports as the destination port of the routing expression.

As mentioned above, the DDF command specifies the physical signal to logical signal mapping for each model type. In the present embodiment, the DDF command is divided into logical and physical sections. The logical section enumerates the logical ports used by the model type. The same port type may be instantiated more than once, with different port instance names. The physical section maps physical signal names to the logical signals defined in the logical ports enumerated in the logical section. In one embodiment, the DDF command provides for three different types of signal mappings: one-to-one, one-to-many, and many-to-one. In a one-to-one mapping, each physical signal is mapped to one logical signal. In a one-to-many mapping, one physical signal is mapped to more than one logical signal. The “for” keyword is used to define a one-to-many mapping. One-to-many mappings may be used if the physical signal is an output. In a many-to-one mapping, more than one physical signal is mapped to the same logical signal. The “forall” keyword is used to define a many-to-one mapping. Many-to-one mappings may be used if the physical signals are inputs.

The DDF commands allow for the flexibility of mapping portions of multi-bit signals to different logical signals (and not mapping portions of multi-bit physical signals at all). The signalpart type is defined to support this. A signalpart is the left side of a physical signal to logical signal assignment in the physical section of a DDF command. If a portion of a multi-bit physical signal, or a logical signal, is not mapped in a given DDF command, a default mapping is assigned to ensure that each physical and logical signal is assigned (even though the assignment isn't used). The “default logical” keyword is used to define the default mappings of logical signals not connected to a physical signal.

For the BNF descriptions in FIGS. 7-9, the tokens shown have the following definitions: POV is the “POV” command name; PORTWORD is the “port” keyword; NAME is a legal HDL signal name, including the bit index portion (e.g. [x:y] or [z], where x, y, and z are numbers, in a Verilog embodiment) if the signal includes more than one bit; BASENAME is the same as NAME but excludes the bit index portion; SIGNALWORD is the “signal” or “signals” keywords; SCF is the “SCF” command name; SCOPENAME1 is a scoped name using BASENAMES (e.g. BASENAME.BASENAME.BASENAME); DDF is the “DDF” command name; LOGICAL is the “logical” keyword; PHYSICAL is the “physical” keyword; BITWIDTH is the bit index portion of a signal; FORALL is the “forall” keyword; “FOR” is the “for” keyword; and SCOPENAME2 is scoped name using NAMES (e.g. NAME.NAME.NAME).

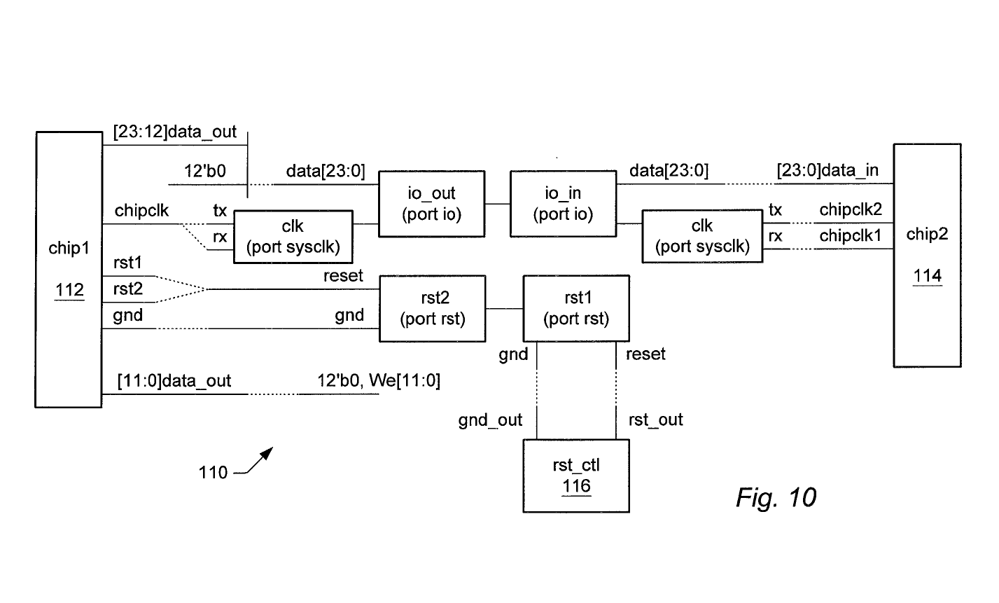

FIGS. 10-15 illustrate an exemplary system under test 110 and a set of POV, DDF, and SCF commands for creating a distributed simulation system for the system under test. In the example, the system under test 110 includes a first chip (chip 1) 112, a second chip (chip 2) 114, and a reset controller circuit (rst_ctl) 116. Each of the chip 1 112, the chip 2 114, and the rst_ctl 116 may be represented by separate HDL models (or other types of models). The signal format used in FIGS. 10-15 is the Verilog format, although other formats may be used.

The chip 1 112 includes a data output signal ([23:0]data_out), a clock output signal (chipclk), two reset inputs (rst1 and rst2), and a ground input (gnd). The chip 2 114 includes a data input signal ([23:0]data in) and two clock input signals (chipclk1 and chipclk2). The rst_ctl 116 provides a ground output signal (gnd_out) and a reset output signal (rst_out). All of the signals in this paragraph are physical signals.

Several ports are defined in the example. Specifically, the port types io, sysclk, and rst are defined. The sysclk port type is a subport of the io port type, and has two logical signal members (tx and rx). The io port type has a clk subport of the sysclk port type and a data signal (having 24 bits) as a member. Two instantiations of io port type are provided (io_out and io_in), and two instantiations of the rst port type are provided (rst1 and rst2). In this example, the port io_out is routed to the port io_in and the port rst1 is routed to the port rst2.

In this example, only the most significant 12 bits of the data output signal of the chip 1 112 are routed to other components (specifically, the chip2 114 ). Thus, the most significant 12 bits of the data output signal are mapped to the most significant bits of the logical signal data[23:0] of the port io_out. The least significant bits are assigned binary zeros as a default mapping, although any value could be used. The chipclk signal of chip1 112 is mapped to both the logical clock signals tx and rx of the port clk. The rst1 and rst2 input signals of chip 1 112 are both mapped to the reset logical signal of the port rst2. The gnd input signal is mapped to the gnd logical signal of the rst2 port.

The data input signal of the chip 2 114 is mapped to the data[23:0] logical signal of port io_in. The chipclk1 signal is mapped to the rx logical signal of the port clk, and the chipclk2 signal is mapped to the tx logical signal of the port clk. Finally, the gnd_out signal of rst ctl 116 is mapped to the gnd logical signal of port rst1 and the rst out signal of rst_ctl 116 is mapped to the reset logical signal of port rst1.

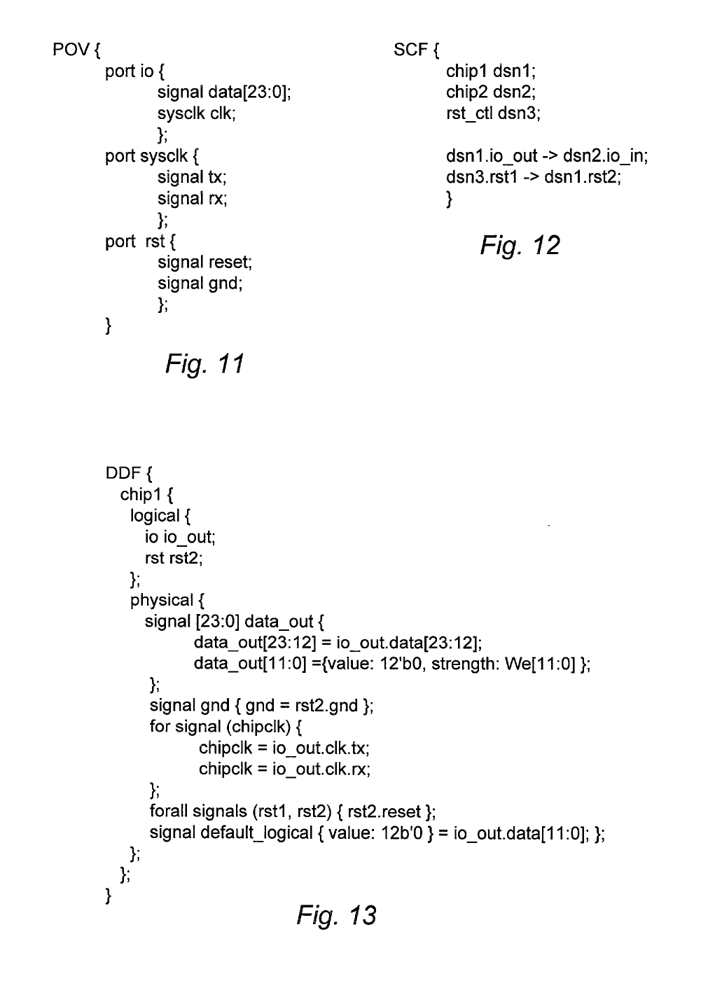

FIG. 11 is an example POV command for the system under test 110. The POV command defines the three port types (io, sysclk, and rst), and the logical signals included in each port type. Port type io includes the logical signal data[23:0] and the subport clk of port type sysclock. Port type sysclock includes the logical signals tx and rx; and the port type rst includes logical signals reset and gnd.

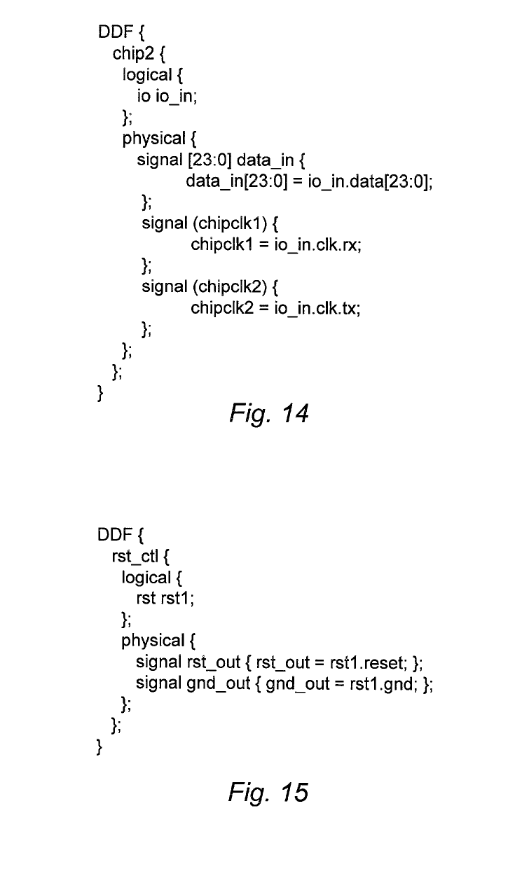

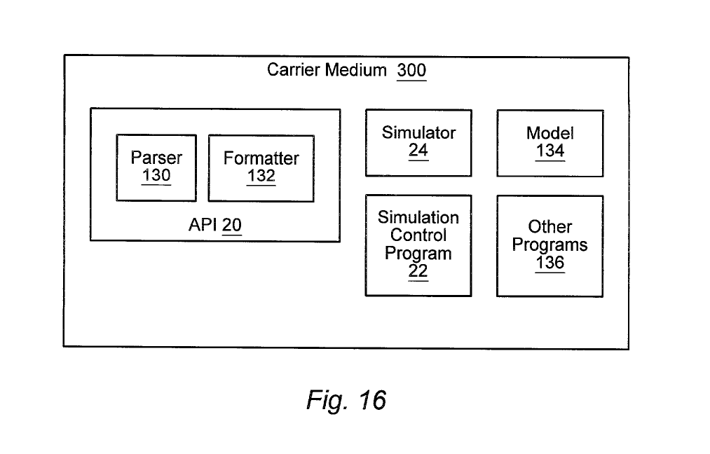

FIG. 12 is an example SCF command for the system under test 110. The SCF file declares three model instances: dsn1 of model type chip1 (for which the DDF command is shown in FIG. 13); dsn2 of model type chip2 (for which the DDF command is shown in FIG. 14); and dsn3 of model type rst_ctl (for which the DDF command is shown in FIG. 15). Additionally, the SCF command includes two routing expressions. The first routing expression (dsn1.io_out−>dsn2.io_in) routes the io_out port of model dsn1 to the io_in port of model dsn2. The second routing expression (dsn3.rst1−>dsn1.rst2) routes the rst1 port of dsn3 to the rst2 port of dsn1.

Thus, for example, a transmit command received from dsn3 as follows:

TRANSMIT{.dsn3{.rst1{gnd={value=0;}; reset={value=1;}; }}}causes the hub to generate a transmit command to dsn1 (due to the second routing expression, by substituting dsn1 and rst2 for dsn3 and rst1, respectively):

TRANSMIT{.dsn1{.rst2{gnd={value=0;}; reset={value=1;}; }}}

As mentioned above, the parser in the hub may parse the transmit command received from dsn3 and may route the logical signals using the child-sibling trees and hash table, and the formatter may construct the command to dsn1.

In the DDF command for chip1 (FIG. 13), the logical section instantiates two logical ports (io_out of port type io, and rst2 of port type rst). The physical section includes a one-to-one mapping of the data output signal in two parts: the most significant 12 bits and the least significant 12 bits. The most significant 12 bits are mapped to the logical signal io out_.data[23:12]. The least significant 12 bits are mapped to the weak binary zero signals. A one-to-one mapping of the physical signal gnd to the logical signal rst2.gnd is included as well.

The physical section also includes a one-to-many mapping for the chipclk signal. The keyword “for” is used to signify the one-to-many mapping, and the assignments within the braces map the chipclk signal to both the logical signals in the clk subport:

io_out.clk.tx and io_out.clk.rx.

The physical section further includes a many-to-one mapping for the rst1 and rst2 physical signals. Both signals are mapped to the logical signal rs2.reset. The keyword “forall” is used to signify the many-to-one mapping. The physical signals mapped are listed in the parentheses (rst1 and rst2 in this example), and the logical signal to which they are mapped is listed in the braces (rst2.reset in this example).

Finally, the physical section includes a default logical signal mapping, providing a default value for the least significant 12 bits of the logical signal io_out.data. Specifically, binary zeros are used in this case.

Accordingly, the DDF command in FIG. 13 illustrates the one-to-one, many-to-one, and one-to-many mappings described above.

FIG. 14 illustrates the DDF command for chip2, with a single logical port io_in of port type io in the logical section and one-to-one signal mappings in the physical section. Similarly, FIG. 15 illustrates the DDF command for rst_ctl, with a single logical port rst1 of port type rst and one-to-one signal mappings in the physical section.

Turning next to FIG. 16, a block diagram of a carrier medium 300 is shown. Generally speaking, a carrier medium may include computer readable media such as storage media (which may include magnetic or optical media, e.g., disk or CD-ROM), volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

The carrier medium 300 is shown storing the API 20, which may include a parser 130 corresponding to the flowchart of FIG. 3 and a formatter 132 corresponding to the flowchart of FIG. 4. Other embodiments may store only one of the parser 130 or the formatter 132. Still further, other programs may be stored (e.g. the simulation control program 22, the simulator 24, and other programs 136 which may include one or more of the programming language model 32, the program 34, the control program 38, programs from the emulator 36, or any other desired programs, etc.). The carrier medium 300 may still further store a model 134, which may include one or more of the models 26, 28, or 30. The carrier medium 300 as illustrated in FIG. 16 may represent multiple carrier media in multiple computer systems on which the distributed simulation system 10 executes.

Numerous variations and modifications will become apparent to those skilled in the art once the above disclosure is fully appreciated. It is intended that the following claims be interpreted to embrace all such variations and modifications.

What is claimed is:

1. A distributed simulation system comprising:
a first node configured to simulate a first portion of a system under test using a first simulation mechanism; and
a second node configured to simulate a second portion of the system under test using a second simulation mechanism different from the first simulation mechanism;
wherein the first node and the second node are configured to communicate during a simulation using a predefined grammar.

2. The distributed simulation system as recited in claim 1 wherein the first simulation mechanism includes a first simulator and a first model of the first portion, and wherein the second simulation mechanism includes one or more programs which, when executed, model the second portion.

3. The distributed simulation system as recited in claim 2 wherein the first model is a register-transfer level model of the first portion.

4. The distributed simulation system as recited in claim 2 wherein the first model is a behavioral level model of the first portion.

5. The distributed simulation system as recited in claim 2 wherein the first model is a hardware verification language model of the first portion.

6. The distributed simulation system as recited in claim 2 wherein the first model is a Superlog model of the first portion.

7. The distributed simulation system as recited in claim 2 wherein the one or more programs are coded in a programming language and compiled for execution.

8. The distributed simulation system as recited in claim 7 wherein the programming language is C.

9. The distributed simulation system as recited in claim 7 wherein the programming language is C++.

10. The distributed simulation system as recited in claim 7 wherein the programming language is Java.

11. The distributed simulation system as recited in claim 1 wherein the first simulation mechanism includes a hardware implementation of the first portion and code for interfacing to the hardware.

12. The distributed simulation system as recited in claim 11 wherein the second simulation mechanism includes one or more programs which, when executed, model the second portion.

13. The distributed simulation system as recited in claim 11 wherein the second simulation mechanism includes a simulator and a model of the second portion.

14. The distributed simulation system as recited in claim 1 wherein the first simulation mechanism includes an emulator configured to emulate the first portion.

15. A carrier medium carrying a first one or more programs included in a first simulation mechanism for simulating a first portion of a system under test in a first node of a distributed simulation system and a second one or more programs included in a second simulation mechanism for simulating a second portion of the system under test in a second node of a distributed simulation system, the second simulation mechanism differing from the first simulation mechanism, wherein the first node and the second node communicate during a simulation using a predefined grammar.

16. The carrier medium as recited in claim 15 wherein the first one or more programs includes a first simulator, and wherein the first simulation mechanism further includes a first model of the first portion, and wherein the second one or more programs, when executed, model the second portion.

17. The carrier medium as recited in claim 16 wherein the first model is a register-transfer level model of the first portion.

18. The carrier medium as recited in claim 16 wherein the first model is a behavioral level model of the first portion.

19. The carrier medium as recited in claim 16 wherein the first model is a hardware verification language model of the first portion.

20. The carrier medium as recited in claim 16 wherein the first model is a Superlog model of the first portion.

21. The carrier medium as recited in claim 16 wherein the second one or more programs are coded in a programming language and compiled for execution.

22. The carrier medium as recited in claim 21 wherein the programming language is C.

23. The carrier medium as recited in claim 21 wherein the programming language is C++.

24. The carrier medium as recited in claim 21 wherein the programming language is Java.

25. The carrier medium as recited in claim 15 wherein the first simulation mechanism includes a hardware implementation of the first portion, and wherein the first one or more programs include code for interfacing to the hardware.

26. The carrier medium as recited in claim 15 wherein the first simulation mechanism includes an emulator configured to emulate the first portion.

27. An apparatus comprising:
a first means for simulating a first portion of a system under test using a first simulation mechanism;
a second means for simulating a second portion of the system under test using a second simulation mechanism different from the first simulation mechanism; and
means for communicating between the first means and the second means during a simulation using a predefined grammar.

28. The apparatus as recited in claim 27 wherein the first simulation mechanism includes a first simulator and a first model of the first portion, and wherein the second simulation mechanism includes one or more programs which, when executed, model the second portion.

29. The apparatus as recited in claim 27 wherein the first simulation mechanism includes a hardware implementation of the first portion and code for interfacing to the hardware.

30. The apparatus as recited in claim 27 wherein the first simulation mechanism includes an emulator configured to emulate the first portion.

31. A method comprising:
simulating a first portion of a system under test in a first node of a distributed simulation system, the simulating using a first simulation mechanism;
simulating a second portion of a system under test in a second node of the distributed simulation system, the simulating using a second simulation mechanism different from the first simulation mechanism; and
communicating between the first node and the second node during a simulation using a predefined grammar.

32. The method as recited in claim 31 wherein the first simulation mechanism includes a first simulator and a first model of the first portion, and wherein the second simulation mechanism includes one or more programs which, when executed, model the second portion.

33. The method as recited in claim 31 wherein the first simulation mechanism includes a hardware implementation of the first portion and code for interfacing to the hardware.

34. The method as recited in claim 31 wherein the first simulation mechanism includes an emulator configured to emulate the first portion.
